(19) United States
(12) Patent Application Publication
(10) Pub. No.: US 2023/0079694 A1
(43) Pub. Date: Mar. 16, 2023

(54) DETERMINATION DEVICE AND DETERMINATION METHOD

(71) Applicant: JVCKENWOOD Corporation, Yokohama-shi (JP)

(72) Inventors: Eiichi HOSONO, Yokohama-shi (JP); Yusuke SHIMIZU, Yokohama-shi (JP); Koki MAENO, Yokohama-shi (JP); Masaaki YAMAGUCHI, Yokohama-shi (JP); Daisuke KOJIMA, Yokohama-shi (JP)

(21) Appl. No.: 18/056,740

(22) Filed: Nov. 18, 2022

Related U.S. Application Data
(63) Continuation of application No. PCT/JP2021/028069, filed on Jul. 29, 2021.

(30) Foreign Application Priority Data
Oct. 28, 2020 (JP) 2020-180326

(51) Int. Cl. A63B 71/06; G06V 20/50; G06V 40/20; A63B 69/00

(52) U.S. Cl. CPC A63B 71/0686; G06V 20/50; G06V 40/25; A63B 69/0028; A63B 71/0622; A63B 2220/05; A63B 2220/806; A63B 2225/50; A63B 2071/0666; A63B 2071/0625

(57) ABSTRACT

A storage stores setting information of a user related to running. An acquirer acquires information of a plurality of runners existing around the user. A determiner specifies one runner from the plurality of runners on the basis of the setting information stored in the storage and the information acquired by the acquirer. An outputter outputs presentation information for presenting one runner specified by the determiner to the user.

### CROSS REFERENCE TO RELATED APPLICATION

This application is a Continuation of International Application No. PCT/JP2021/028069, filed on Jul. 29, 2021, which in turn claims the benefit of Japanese Application No. 2020-180326, filed on Oct. 28, 2020, the disclosures of which Application is incorporated by reference herein.

### BACKGROUND

### 1. Field

The present invention relates to a determination device and a determination method for determining a runner to be a pacemaker.

### 2. Description of the Related Art

A large number of runners participate in a marathon race. In order to make a good record in the marathon race, it is effective to find a pacemaker suitable for one's ability and run behind the pacemaker. Regarding the pacemaker, it is conceivable to display a virtual runner who runs at a pace set by a user on display glasses worn by the running user (for example, see Patent Literature 1). In particular, this is an effective method at the time of running alone.
Patent Literature 1: JP 2014-54303 A

Since the virtual runner does not serve as a windbreak, in an actual race, it is desirable to find a pacemaker suitable for oneself from a plurality of runners who actually exist in the surroundings.

### SUMMARY

A determination device according to an aspect of the present embodiment includes: a storage that stores setting information of a user related to running; an acquirer that acquires information of a plurality of runners existing around the user; a determiner that specifies one runner from the plurality of runners on the basis of the setting information stored in the storage and the information acquired by the acquirer; and an outputter that outputs presentation information for presenting one runner specified by the determiner to the user.

Another aspect of the present embodiment is a determination method. This method includes: a step of acquiring information of a plurality of runners existing around a user; a step of specifying one runner from the plurality of runners on the basis of setting information of the user related to running stored in advance and the acquired information; and a step of outputting presentation information for presenting the specified one runner to the user.

Note that arbitrary combinations of the above components and modifications of the expressions of the present embodiment between devices, systems, methods, computer programs, recording media storing the computer programs, and the like are also effective as aspects of the present embodiment.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a diagram illustrating functional blocks of a wearable terminal device according to a first embodiment of the present invention.

FIG. 2 is a diagram illustrating a configuration example of the wearable terminal device according to the first embodiment.

FIG. 3 is a diagram illustrating an example of a state in which a picture recognizer of the wearable terminal device according to the first embodiment recognizes a plurality of runners in a frame.

FIG. 4 is a diagram illustrating a display example for causing a user to recognize a runner to be a pacemaker in the wearable terminal device according to the first embodiment.

FIG. 5 is a diagram illustrating functional blocks of a wearable terminal device according to a second embodiment of the present invention.

FIG. 6 is a diagram illustrating an example of a state in which a determiner of the wearable terminal device according to the second embodiment has grasped a relative positional relation between a user and a plurality of runners existing around the user, on the basis of near field communication.

FIG. 7 is a diagram illustrating a display example for causing a user to recognize a runner to be a pacemaker in the wearable terminal device according to the second embodiment.

### DETAILED DESCRIPTION

The invention will now be described by reference to the preferred embodiments. This does not intend to limit the scope of the present invention, but to exemplify the invention.

### First Embodiment

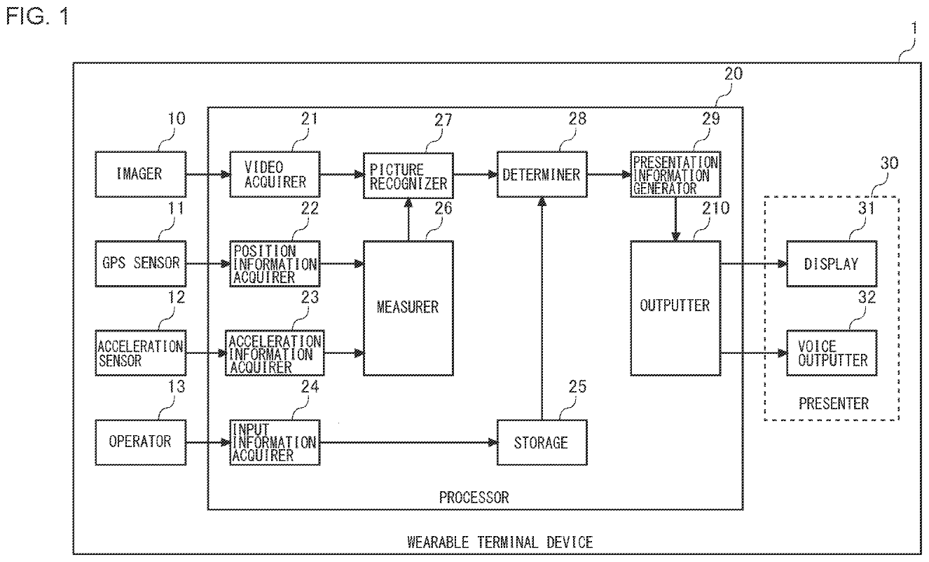

FIG. 1 is a diagram illustrating functional blocks of a wearable terminal device 1 according to a first embodiment of the present invention. The wearable terminal device 1 according to the first embodiment is a glasses-type terminal device worn on a runner, and has a function of searching for a runner to be a pacemaker from other runners located around the runner.

The wearable terminal device 1 according to the first embodiment includes an imager 10, a GPS sensor 11, an acceleration sensor 12, an operator 13, a processor 20, and a presenter 30. The imager 10 is a camera for photographing the periphery of a runner (hereinafter, referred to as a user) wearing the wearable terminal device 1. For example, the imager 10 is fixed to a frame of the glasses-type wearable terminal device 1, and mainly photographs the front of the user in a traveling direction. When a camera having an ultra-wide-angle lens such as a fisheye lens is used, not only the front but also a wider range can be kept within an angle of view. For example, when an external camera is installed on a hat, the entire circumference of 360° can be kept within the angle of view.

The imager 10 includes a solid-state imaging element and a signal processing circuit. As the solid-state imaging element, for example, a complementary metal oxide semiconductor (CMOS) image sensor or a charge coupled device (CCD) image sensor can be used. The solid-state imaging element converts incident light into an electrical video signal and outputs the electrical video signal to the signal processing circuit. The signal processing circuit performs signal processing such as A/D conversion and noise removal on the video signal input from the solid-state imaging element, and outputs the video signal to the processor 20.

The GPS sensor 11 detects a current position of the wearable terminal device 1 and outputs the current position to the processor 20. Specifically, signal transmission times are received from a plurality of GPS satellites, and latitude and longitude of a reception point are calculated on the basis of the plurality of received signal transmission times. The acceleration sensor 12 detects acceleration components of three axes applied to the wearable terminal device 1 and outputs the acceleration components to the processor 20.

The operator 13 has a button, a touch panel, and the like, and receives input from the user. For example, the operator 13 receives setting information such as a target speed (for example, 4 minutes per kilometer) of running, a target pitch of running, and the like from the user. The setting information needs to be input before a running competition (for example, a marathon race) in which a plurality of runners participate.

The processor 20 includes a video acquirer 21, a position information acquirer 22, an acceleration information acquirer 23, an input information acquirer 24, a storage 25, a measurer 26, a picture recognizer 27, a determiner 28, a presentation information generator 29, and an outputter 210. These functions of the processor 20 can be implemented by cooperation of hardware resources and software resources or only hardware resources. As the hardware resources, a CPU, a ROM, a RAM, a graphics processing unit (GPU), a digital signal processor (DSP), an image signal processor (ISP), an application specific integrated circuit (ASIC), a field-programmable gate array (FPGA), a system on a chip (SoC), and other LSIs can be used. A program such as firmware can be used as the software resource.

The input information acquirer 24 acquires the setting information related to running such as the target speed of running input from the operator 13. The storage 25 stores the setting information related to running acquired by the input information acquirer 24.

The position information acquirer 22 acquires the current position information of the user wearing the wearable terminal device 1 from the GPS sensor 11. The acceleration information acquirer 23 acquires the acceleration component information of the three axes applied to the wearable terminal device 1 from the acceleration sensor 12.

The measurer 26 measures the speed of the user on the basis of the current position information of the user acquired by the position information acquirer 22. As the simplest processing, the measurer 26 specifies a distance between two points and a time between two times when the position information of the two points has been acquired on the basis of the position information of the two points, and measures the speed on the basis of the distance and the time.

The measurer 26 measures the pitch (the number of steps per unit time) of the user on the basis of the acceleration components of the three axes acquired by the acceleration information acquirer 23. During running or walking of the user, regardless of the orientation of the acceleration sensor 12, the acceleration component of one axis among the acceleration components in the X-axis, Y-axis, and Z-axis directions has a larger relative periodic change with respect to the acceleration components of the other two axes. The measurer 26 measures the pitch of the user by continuously detecting a peak value of the acceleration component of one axis having the largest periodic change.

The video acquirer 21 acquires a video captured by the imager 10. The picture recognizer 27 searches for an object (in the present specification, a runner) in each frame of the acquired video. The picture recognizer 27 has a discriminator of the runner generated by learning a large number of pictures showing the runner as dictionary data.

The picture recognizer 27 searches the frame of the video using the discriminator of the runner. For recognizing the runner (object), for example, histograms of oriented gradients (HOG) feature amounts can be used. Note that a Haar-like feature amount, a local binary patterns (LBP) feature amount, or the like may be used. When the runner exists in the frame, the picture recognizer 27 captures the runner with a rectangular detection frame. When a plurality of runners exist in the frame, the picture recognizer 27 individually recognizes each runner.

The picture recognizer 27 tracks each runner recognized in the frame in a subsequent frame. For tracking the runner (object), for example, a particle filter or a mean shift method can be used.

The picture recognizer 27 estimates a relative speed of each runner on the basis of a position of each runner in a plurality of frames captured continuously. Specifically, the picture recognizer 27 estimates a distance from the imager 10 to the runner at an imaging time of a first frame, on the basis of the y coordinate of the position of the runner in the first frame and a table or a function prepared in advance. Similarly, the picture recognizer 27 estimates a distance from the imager 10 to the runner at an imaging time of a second frame, on the basis of the y coordinate of the position of the runner in the second frame and a table or a function prepared in advance.

The table or function describes a relation between the y coordinate of the position of the runner in the frame and the distance from the imager 10 to the runner, and is determined according to the assumed mounting position (height from a road surface) of the imager 10 and the angle of view of the imager 10.

Note that, in a case where the imager 10 includes a binocular stereo camera, a distance estimator not illustrated in the drawings can estimate a distance from the imager 10 to the runner on the basis of the parallax of the pictures captured by the two eyes. Further, in a case where a time of flight (TOF) sensor such as light detection and ranging (LiDAR) is mounted on the imager 10, the distance estimator can estimate the distance from the imager 10 to the runner on the basis of a detection value of the TOF sensor.

The picture recognizer 27 subtracts the distance from the imager 10 to the runner at the imaging time of the first frame from the distance from the imager 10 to the runner at the imaging time of the second frame, and estimates a traveling distance of the runner between the imaging time of the first frame and the imaging time of the second frame. The picture recognizer 27 estimates the relative speed of the runner on the basis of the distance and the time between the imaging time of the first frame and the imaging time of the second frame.

The picture recognizer 27 acquires the running speed of the user from the measurer 26. The picture recognizer 27 estimates an absolute speed of the runner by adding the user speed to the relative speed of the runner estimated as described above. When a plurality of runners exist around the user, the absolute speed is estimated for each runner.

The determiner 28 specifies one runner to be a pacemaker from the plurality of runners, on the basis of the setting information related to running stored in the storage 25 and the information of the plurality of runners existing around the user recognized by the picture recognizer 27.

For example, the determiner 28 determines a runner having a speed closest to the target speed of the user stored in the storage 25 among the speeds of the plurality of runners recognized by the picture recognizer 27 as a runner to be a pacemaker. Note that the determiner 28 may set an absolute condition for determining the runner as the pacemaker.

For example, a speed condition may be imposed that the runner selected as the pacemaker is limited to a runner who is running at a speed different from the target speed of the user within a predetermined value. In this case, even in a case where at least one runner exists around the user, when there is no runner satisfying the speed condition, the pacemaker is not selected. A runner having a large deviation from the target speed is not suitable for the pacemaker.

In addition, a distance condition that the runner selected as the pacemaker is limited to a runner whose distance to the user is within a predetermined distance may be imposed. In this case, even in a case where at least one runner exists around the user, when there is no runner satisfying the distance condition, the pacemaker is not selected.

Further, in a case where there are a plurality of runners satisfying the speed condition and the distance condition around the user, the determiner 28 may select a runner to be the pacemaker in consideration of another additional condition.

For example, the picture recognizer 27 recognizes a vertical movement of the foot of each runner tracked by the picture recognizer 27 in the frame, and measures a pitch of each runner. When there are a plurality of runners satisfying the distance condition and the speed condition around the user, the determiner 28 selects a runner having a pitch closest to the target pitch of the user stored in the storage 25 as a runner to be the pacemaker. When the pitch is closer, it is easier to run behind.

Further, the picture recognizer 27 scores the quality of a running form of each runner tracked by the picture recognizer 27 in the frame using a form scoring discriminator. When there are a plurality of runners satisfying the distance condition and the speed condition around the user, the determiner 28 selects a runner having a highest score in the running form as a runner to be the pacemaker. A runner who has a good running form is easy to run behind.

Further, the picture recognizer 27 recognizes a size of a body of each runner recognized in the frame. When there are a plurality of runners satisfying the distance condition and the speed condition around the user, the determiner 28 selects a runner having the highest body as a runner to be the pacemaker. It is better to run behind a runner having a large body to reduce air resistance.

Further, in a case where there are a plurality of runners satisfying the distance condition and the speed condition around the user, the determiner 28 may score the running speed, the running pitch, the running form, and the body size of each runner on the basis of a predetermined standard, and select a runner having a highest total value of scores as a runner to be the pacemaker.

The presentation information generator 29 generates presentation information for notifying the user of one runner specified by the determiner 28. A specific example of the presentation information will be described later. The outputter 210 outputs the generated presentation information to the presenter 30.

The presenter 30 is a user interface for notifying the user of a runner to be the pacemaker. The presenter 30 includes a display 31 and a voice outputter 32. The display 31 includes a display such as a liquid crystal display, an organic EL display, or a micro LED display. When the display 31 receives the presentation information from the outputter 210, the display 31 displays a picture indicating a runner to be the pacemaker on a lens of glasses as an augmented reality (AR) picture.

The voice outputter 32 includes a speaker. When the voice outputter 32 receives the presentation information from the outputter 210, the voice outputter 32 outputs a voice guidance indicating a runner to be the pacemaker. For example, the voice guidance “a runner is 3 m ahead on the left” is output. Note that the presentation of the pacemaker to the user is performed using at least one of the display 31 and the voice outputter 32.

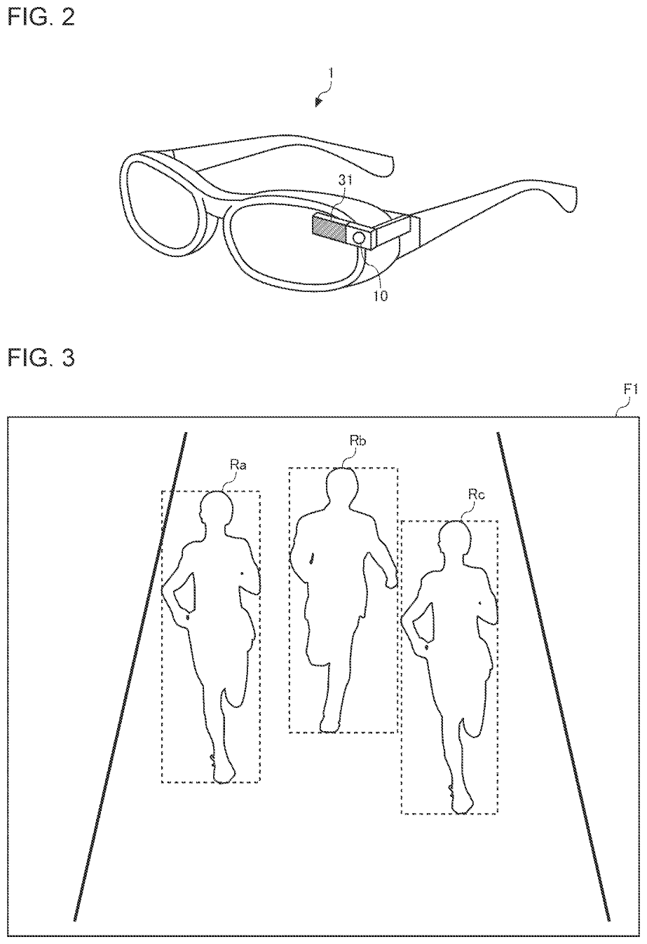

FIG. 2 is a diagram illustrating a configuration example of the wearable terminal device 1 according to the first embodiment. FIG. 2 illustrates an example in which the wearable terminal device 1 according to the first embodiment is constituted by transmissive smart glasses. A prescription lens or a non-prescription lens may be used. Sunglasses may be used. In the example illustrated in FIG. 2, a small display 31 is attached to the upper left outside a left lens. The imager 10 is attached at a neighboring position of the display 31. Note that a head-up display (HUD) that projects a video onto the lens may be used as the display 31.

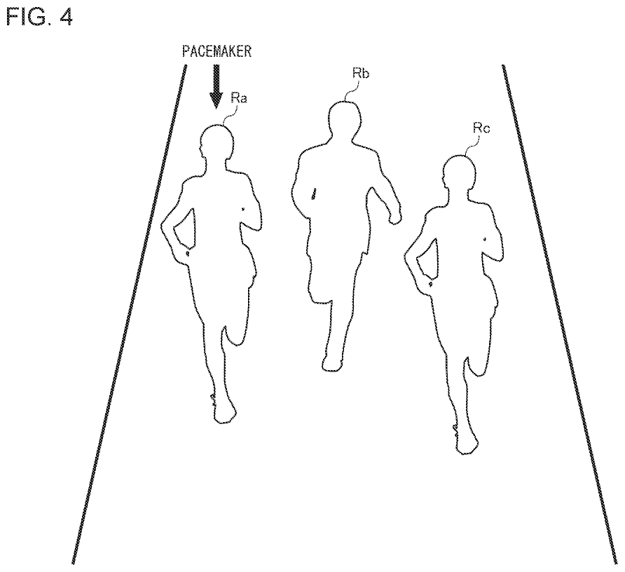

FIG. 3 is a diagram illustrating an example of a state in which the picture recognizer 27 of the wearable terminal device 1 according to the first embodiment has recognized a plurality of runners Ra, Rb, and Rc in a frame F1. Here, it is assumed that the determiner 28 determines that the runner Ra on the front left is a runner to be the pacemaker.

FIG. 4 is a diagram illustrating a display example for causing a user to recognize the runner Ra to be the pacemaker in the wearable terminal device 1 according to the first embodiment. In the example illustrated in FIG. 4, an arrow indicating the runner Ra to be the pacemaker and letters of the pacemaker are displayed.

As described above, according to the first embodiment, it is possible to search for a pacemaker suitable for the user from the periphery of the user. For example, even in a marathon race, it is possible to easily search for an appropriate runner to be the pacemaker from a large number of other runners running near oneself. In the first embodiment, since wireless communication is not required, it is possible to accurately find a runner to be the pacemaker even in an environment with poor radio wave conditions.

### Second Embodiment

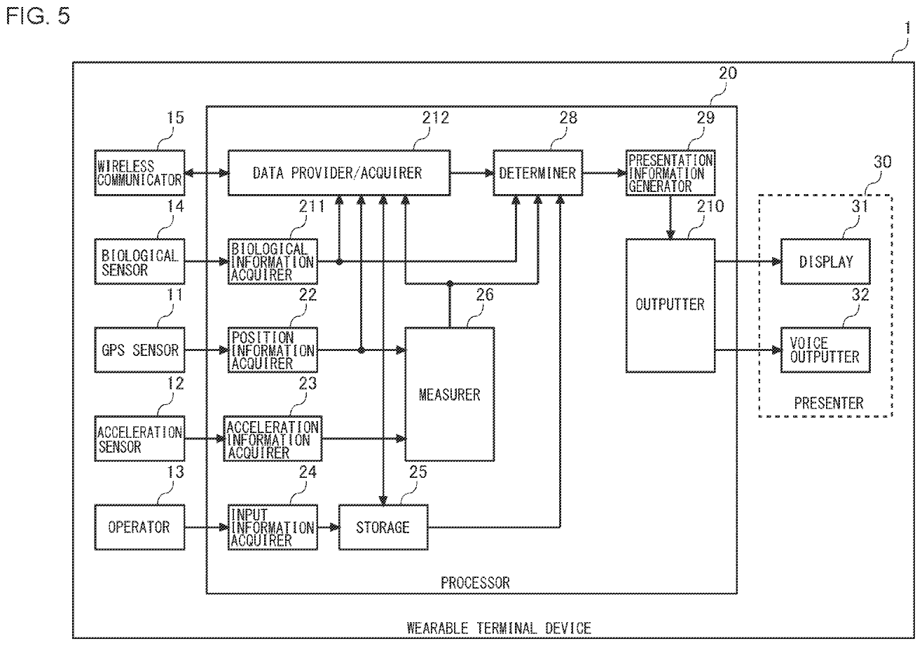

FIG. 5 is a diagram illustrating functional blocks of a wearable terminal device 1 according to a second embodiment of the present invention. The wearable terminal device 1 according to the second embodiment is a watch-type terminal device worn by a runner, and has a function of searching for a runner to be a pacemaker from other runners located around the runner, similarly to the first embodiment. Note that an imager 10 is not essential in the wearable terminal device 1 according to the second embodiment. Hereinafter, the wearable terminal device 1 on which the imager 10 is not mounted will be described.

The wearable terminal device 1 according to the second embodiment includes a GPS sensor 11, an acceleration sensor 12, an operator 13, a biological sensor 14, a wireless communicator 15, a processor 20, and a presenter 30. Hereinafter, differences from the wearable terminal device 1 according to the first embodiment will be described.

The biological sensor 14 is worn by a user, measures biological information of the user, and outputs the measured biological information to the processor 20. As the biological sensor 14, for example, an optical heart rate sensor can be used. The optical heart rate sensor is mounted on the wrist of the user, irradiates the wrist with LED light, and measures an amount of light scattered by a blood flow in a blood vessel, thereby measuring a heart rate. In addition, a blood oxygen concentration can be measured by setting a plurality of (for example, green, red, and infrared) LED lights of the optical heart rate sensor. In addition, a pulse sensor that directly measures the electrocardiogram by causing a weak electric signal to flow to a human body may be used.

The wireless communicator 15 executes near field communication. Bluetooth (registered trademark), Wi-Fi (registered trademark), infrared communication, and the like can be used as the near field communication. The wireless communicator 15 can wirelessly communicate with another wearable terminal device 1 worn by each of a plurality of runners existing around the user. For example, by peer to peer (P2P) or a mesh network, wireless communication can be directly performed between two or more wearable terminal devices 1 located within a predetermined distance range without an access point.

In the second embodiment, the processor 20 includes a position information acquirer 22, an acceleration information acquirer 23, an input information acquirer 24, a biological information acquirer 211, a data provider/acquirer 212, a storage 25, a measurer 26, a determiner 28, a presentation information generator 29, and an outputter 210.

In the second embodiment, in addition to a target speed of running and a target pitch of running, the user inputs setting information such as a target time of a marathon race and a result time of a past marathon race from the operator 13. The input information acquirer 24 acquires the setting information related to running such as the target speed of running input from the operator 13, and stores the setting information in the storage 25.

The biological information acquirer 211 acquires the biological information of the user from the biological sensor 14. For example, a heart rate and a blood oxygen concentration are acquired as the biological information.

The data provider/acquirer 212 can transmit the position information of the user and at least one of the running speed, the running pitch, the biological data, the target time, and the result time of the user to other wearable terminal device 1 via the wireless communicator 15. In addition, the data provider/acquirer 212 can receive the position information of other runner and at least one of the running speed, the running pitch, the biological data, the target time, and the result time of other runner from other wearable terminal device 1 via the wireless communicator 15.

The determiner 28 specifies one runner to be a pacemaker from the plurality of runners, on the basis of the setting information related to running stored in the storage 25 and the information of the plurality of runners existing around the user acquired by the data provider/acquirer 212.

For example, the determiner 28 determines a runner having a speed closest to the target speed of the user stored in the storage 25 among the speeds of the plurality of runners acquired by the data provider/acquirer 212 as a runner to be the pacemaker. Note that, similarly to the first embodiment, the determiner 28 may set an absolute condition for determining the runner as the pacemaker.

Further, the determiner 28 may narrow down runners to be the pacemaker, on the basis of other data of the plurality of runners acquired by the data provider/acquirer 212.

For example, the determiner 28 may exclude a runner whose heart rate included in the acquired biological data is higher than a reference value from the selection candidates of the pacemaker. A runner having an excessively high heart rate can be estimated to have a high probability of decreasing the pace in the future, and is determined to be not suitable for the pacemaker.

Further, the determiner 28 may exclude a runner whose deviation between the acquired target time or result time of the marathon and the prediction time based on the current pace is larger than or equal to a predetermined value from the selection candidates of the pacemaker. In a case where the target time or the result time is greatly different from the prediction time based on the current pace, it can be estimated that the pace is likely to decrease or increase in the future, and it is determined that the runner is not suitable for the pacemaker.

The presentation information generator 29 generates presentation information for notifying the user of one runner specified by the determiner 28. In the second embodiment, for example, the presentation information generator 29 generates a schematic overhead picture indicating a relative positional relation between the user and at least one runner existing around the user, on the basis of position information acquired from a plurality of wearable terminal devices 1 worn by a plurality of runners. The outputter 210 outputs the generated presentation information to the presenter 30.

When the display 31 receives the presentation information from the outputter 210, the display 31 displays the received overhead picture. When the voice outputter 32 receives the presentation information from the outputter 210, the voice outputter 32 outputs a voice guidance indicating a runner to be the pacemaker. Note that the presentation of the pacemaker to the user is performed using at least one of the display 31 and the voice outputter 32.

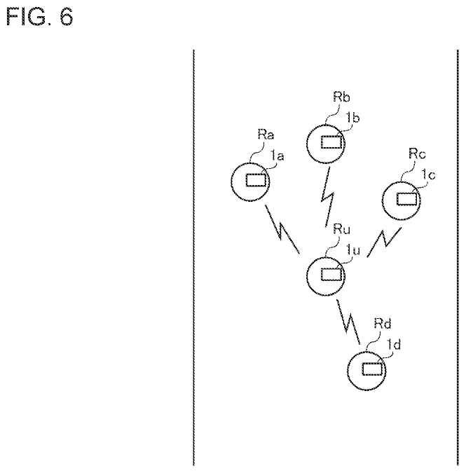

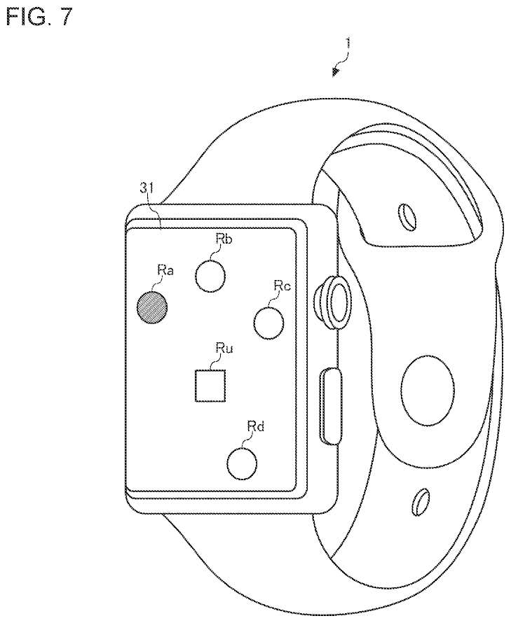

FIG. 6 is a diagram illustrating an example of a state in which the determiner 28 of the wearable terminal device 1 according to the second embodiment has grasped a relative positional relation between a user Ru and a plurality of runners Ra, Rb, Rc, and Rd existing around the user Ru on the basis of the near field communication. Here, it is assumed that the determiner 28 determines that the runner Ra on the front left is a runner to be the pacemaker.

FIG. 7 is a diagram illustrating a display example for causing the user to recognize the runner Ra to be the pacemaker in the wearable terminal device 1 according to the second embodiment. In the example illustrated in FIG. 7, the runner Ra to be the pacemaker is marked in the display 31 of the watch-type wearable terminal device 1.

As described above, according to the second embodiment, it is possible to search for a pacemaker suitable for the user from the periphery of the user. For example, even in a marathon race, it is possible to easily search for an appropriate runner to be the pacemaker from a large number of other runners running near oneself. In the second embodiment, since wireless communication is used, it is possible to easily acquire information of a runner running behind.

The present invention has been described on the basis of the embodiments. The embodiments are merely examples, and it is understood by those skilled in the art that various modifications can be made in the combination of the respective components or the respective processing processes, and that the modifications are also within the scope of the present invention.

For example, the wireless communicator 15 may be added to the glasses-type wearable terminal device 1 according to the first embodiment. Further, the external biological sensor 14 may be added. In this case, the wireless communication can be used to acquire at least one of speeds, pitches, biological data, target times, and result times of other runners, and the pacemaker can be selected from a plurality of surrounding runners on the basis of more comprehensive judgment.

Further, the imager 10 may be added to the watch-type wearable terminal device 1 according to the second embodiment. In this case, at least one of speeds, pitches, running forms, and body sizes of other runners can be recognized by the picture recognition, and the pacemaker can be selected from a plurality of surrounding runners on the basis of more comprehensive judgment.

In the first and second embodiments, an example in which the pacemaker is selected from a plurality of runners around the user while the user is running has been described. In this respect, it can also be used in a case where the pacemaker is selected from a plurality of players around the user while the user is racewalking.

What is claimed is:

1. A determination device comprising:
a storage structured to store setting information of a user related to running;
an acquirer structured to acquire information of a plurality of runners existing around the user;
a determiner structured to specify one runner from the plurality of runners on the basis of the setting information stored in the storage and the information acquired by the acquirer; and
an outputter structured to output presentation information for presenting one runner specified by the determiner to the user.

2. The determination device according to claim 1, wherein
the determiner compares a running speed stored as the setting information in the storage with running speeds of the plurality of runners based on the information acquired by the acquirer, and specifies one runner from the plurality of runners.

3. The determination device according to claim 1, wherein
the acquirer acquires a video from an imager that photographs the periphery of the user,
the determination device further comprises: a picture recognizer structured to recognize pictures of the plurality of runners from the video acquired by the acquirer,
the picture recognizer recognizes at least one of running speeds, running pitches, running forms, and body sizes of the plurality of runners, and
the determiner specifies one runner from the plurality of runners on the basis of at least one of a running speed and a running pitch stored as the setting information in the storage, and at least one of running speeds, running pitches, running forms, and body sizes of the plurality of runners whose picture have recognized by the picture recognizer.

4. The determination device according to claim 1, wherein
the acquirer acquires at least one of running speeds, running pitches, biological data, target times, and result times of the plurality of runners from determination devices of the plurality of runners via wireless communication, and
the determiner specifies one runner from the plurality of runners, on the basis of at least one of a running speed, a running pitch, a target time, and a result time stored as the setting information in the storage, and at least one of running speeds, running pitches, biological data, target times, and result times of the plurality of runners acquired by the acquirer.

5. A determination method comprising:
a step of acquiring information of a plurality of runners existing around a user;
a step of specifying one runner from the plurality of runners on the basis of setting information of the user related to running stored in advance and the acquired information; and
a step of outputting presentation information for presenting the specified one runner to the user.
